(19) United States
(12) Patent Application Publication
(10) Pub. No.: US 2007/0001579 A1
(43) Pub. Date: Jan. 4, 2007

(54) GLASS-TO-GLASS JOINING METHOD USING LASER, VACUUM ENVELOPE MANUFACTURED BY THE METHOD, ELECTRON EMISSION DISPLAY HAVING THE VACUUM ENVELOPE

(76) Inventors: EUN-SUK JEON, Suwon-si (KR); Sergey Antipin, Moscow (RU); Hoe-Rok Jung, Suwon-si (KR)

Correspondence Address: ROBERT E. BUSHNELL, 1522 K STREET NW, SUITE 300, WASHINGTON, DC, 20005-1202, US

(21) Appl. No.: 11/427,195

(22) Filed: Jun. 28, 2006

Related U.S. Application Data
(60) Provisional application No. 60/695,188, filed on Jun. 30, 2005.

(51) Int. Cl. H01J 9/26; H01J 63/04

(52) U.S. Cl. 313/495; 313/496; 445/25

(57) ABSTRACT

A method for joining multiple parts contemplates arranging the parts to be joined together so that the parts contact each other, and then irradiating an interface between the parts through one of the parts in a direction normal to the interface with laser beam in order to form a thermally joined junction around the interface.

### CLAIM OF PRIORITY

This application makes reference to, incorporates the same herein, and claims all benefits accruing under 35 U.S.C.§121 from an application earlier filed in the United States Patent and Trademark Office on 30 Jun. 2005 and there duly assigned Ser. No. 60/695,188.

### BACKGROUND OF THE INVENTION

1. Technical Field

The present invention relates to a glass-to-glass joining method, and more particularly, to a method of directly joining one glass item to another glass item using a laser. The present invention further relates to electron emission displays having vacuum envelopes manufactured by this glass-to-glass joining method.

2. Related Art

Generally, in order to make parts stick together, an adhesive material is used as a medium between the parts.

For example, in an electron emission display such as one of the conventional flat panel displays, spacers are fixed on a substrate with an adhesive material.

The substrate and the spacers are generally formed of glass and each spacer has a fine thickness consonant with the properties of the electron emission display.

A process for joining parts together using the adhesive material is complicated and the adhesive material increases the manufacturing costs.

Since the adhesive material is deformed during a sintering process, the glass parts may be displaced. Therefore, it is difficult to expect accurate bonding and alignment of the parts.

Furthermore, the adhesive material may cause environmental pollution.

When a process for sealing the substrate together and exhausting air out of a vacuum envelope is performed to manufacture a final product using the vacuum envelope incorporating electron emission elements, the degree of the vacuum inside the vacuum envelope may be lowered due to the outgassing generated from the adhesive material, thereby causing a deterioration in the quality of the final product.

As described above, when glass parts are bonded together with an adhesive material, many problems occur which are attributable to the adhesive material. Therefore, there is a need for a joining method without using the adhesive material.

### SUMMARY OF THE INVENTION

It is an object of the present invention to provide an improved process for joining work pieces such as glass without using adhesive materials and improved sealed vacuum envelopes for electron emission displays.

The present invention provides a method of joining parts together without using an adhesive material.

The present invention also provides a vacuum envelope for an electron emission display manufactured by the joining method.

The present invention also provides a method of manufacturing an electron emission display, which can bond spacers on a substrate without using an adhesive material.

The present invention also provides an electron emission display manufactured through the joining method.

The present invention further provides an anode assembly for an electron emission display manufactured by the joining method.

In an exemplary embodiment of the present invention, a joining method contemplates arranging parts that will be joined together with the parts contacting each other and projecting a laser beam to irradiate an interface between the parts to be joined through one of the parts, in a direction normal to the interface to form a thermally joined portion around the interface.

The method of projecting the laser beam may be performed by sequentially projecting laser beams having different energies.

That is, the method of projecting the laser beam includes projecting a first laser beam having a predetermined energy and projecting a second laser beam having an energy lower than the predetermined energy of the first laser beam.

The joining method may incorporate a focusing of the laser beam onto the interface between the parts to be joined together.

The laser beam is preferably generated by a solid state laser. The solid state laser may be a third harmonic Nd/YAG laser.

Alternatively, the laser beam may be generated by an ultra violet (i.e., “UV”) eximer laser.

Alternatively, the laser beam may be generated by a laser with a visible wavelength or a near infrared wavelength. In these implementations of the principles of the present invention, the laser is selected from a group consisting of a fundamental harmonic Nd/YAG laser, a second harmonic Nd/YAG laser and a diode laser.

The parts to be joined together may be formed of glass materials.

The parts to be joined are formed with the shape of a plate and one of the parts is arranged on the other in a perpendicular direction.

The width of the interface is equal to or greater than 0.07 mm.

In another exemplary embodiment of the present invention, a vacuum envelope contemplates first and second substrates facing toward each other and a spacer arranged between the first and second substrates and joining the first substrate by directly contacting the first substrate.

The first substrate and the spacer may be joined together by a laser beam.

A thermally joined portion may be formed around an interface between the first substrate and the spacer by the laser beam.

The thermally joined portion may be formed in a spot having a longitudinal diameter established by the longitudinal sections of the first substrate and the spacer.

The thermally joined portion may have contour lines.

The first substrate and the spacer may be formed of glass materials.

In still another exemplary embodiment, an electron emission display contemplates a cathode substrate on which an electron emission unit is provided, an anode substrate on which a light emission unit is provided, and a spacer arranged between the cathode and anode substrate and joined to the anode substrate; the spacer may be joined to the anode substrate by directly contacting the anode substrate.

The spacer may be formed with a bar shape.

The electron emission display may be a Field Emission Array (FEA) type electron emission display.

In still another exemplary embodiment, an anode assembly of an electron emission display may incorporate a substrate, a light emission unit provided on the substrate and a spacer joined to the substrate by directly contacting the substrate.

In still yet another exemplary embodiment, a method of manufacturing an electron emission display contemplates an arrangement of a spacer so that the spacer directly contacts either one of the anode and cathode substrates and projecting a laser beam to irradiate an interface between the spacer and either one of the anode and cathode substrates bearing the spacer, in a direction normal to the interface, to form a thermally joined portion around the interface.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a concept view for illustrating a joining method as an embodiment of the present invention;

FIG. 2 is an enlarged view of a portion A of FIG. 1;

FIGS. 3 through 5 are schematic views illustrating sequential processes for joining parts together as the embodiment of the present invention; and

FIG. 6 is a sectional view of an electron emission display having a vacuum envelope constructed as an embodiment of the present invention.

### DETAILED DESCRIPTION OF INVENTION

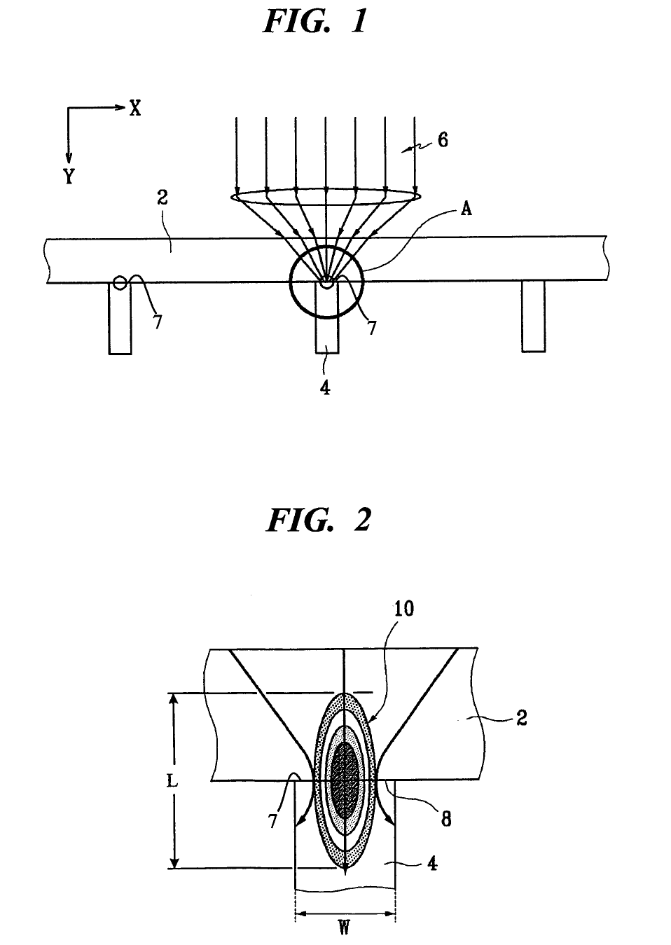

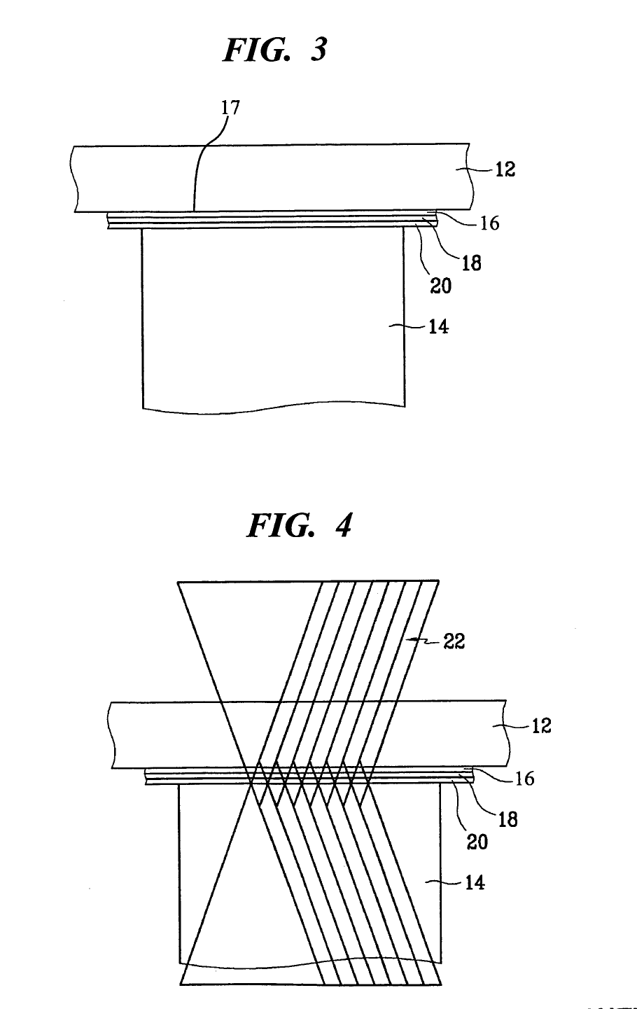

FIG. 1 is a conceptual view illustrating a joining technique as practiced as an embodiment of the present invention and FIG. 2 is an enlarged view of the portion A of FIG. 1.

Referring to FIGS. 1 and 2, a joining technique of this embodiment joins different parts 2 and 4 together by irradiating the interface between parts 2 and 4 with laser beam 6 projecting through one of the parts 2 and 4. That is, parts 2 and 4 are thermally joined together by the heat of laser beam 6.

In this embodiment, substrate 2 and spacer 4 of an electron emission display are respectively exemplars of parts 2 and 4. Substrate 2 and spacer 4 are formed of glass. In the embodiment, the glass may include any kind of glasses (for example: PD 200, soda-lime and borosilicate) that can be used in display products.

In addition, laser beam 6 is irradiated in a direction (a Y-direction in the drawing) which is normal to interface 7 between parts 2 and 4, through substrate 2. At this point, laser beam 6 can be controlled by a laser generation unit (not shown) so that laser beam 6 can have a predetermined energy and can be focused onto interface 7.

As shown in FIG. 2, parts 2 and 4 are thermally joined by laser beam 6 in an orientation where parts 2 and 4 are in direct contact with each other, and a longitudinal axis of one of the parts 2,4 is perpendicularly positioned on the other part.

Since spacer 4 is formed in a fine, and very precise structure having a width of approximately 0.07 mm or more, the joinder of parts 2 and 4 is performed by micro joining, by which a minimum width W of joining surface 8 along interface 7 between parts 2 and 4 can be 0.07 mm or greater. The width of part 4 and joining surface 8 are only examples illustrating the principles of the present invention; the present invention is not limited to the particulars of these exemplars. That is, the widths of part 4 and joining surface 8 can be maintained within a range from 0.07 mm to several milimeters, for example, approximately 5 mm.

As described above, according to this embodiment, parts 2, 4 can be directly joined together by laser beams without using any intermediate medium such as an adhesive material.

By the above described direct joining method, a thermally joined junction 10 is formed around interface 7 between parts 2, 4.

Thermally joined junction 10 can be formed with a predetermined shape by the heat of laser beam 6. In this embodiment, thermally joined junction 10 is formed in a spot having a longitudinal axis oriented with reference to the longitudinal dimensions of parts 2, 4. At this point, thermally joined junction 10 can have contour lines defined by thermal gradients of laser beam 6 with an elliptical cross-sectional pattern as represented in FIG. 2.

Meanwhile, laser beam 6 can be formed by a solid state laser such as a third harmonic Nd:YGA laser.

Alternatively, laser beam 6 can be formed by a UV eximer laser or a laser having a visible ray or near infrared ray such as a fundamental harmonic Nd:YGA laser, a second harmonic Nd:YGA laser, or a diode laser.

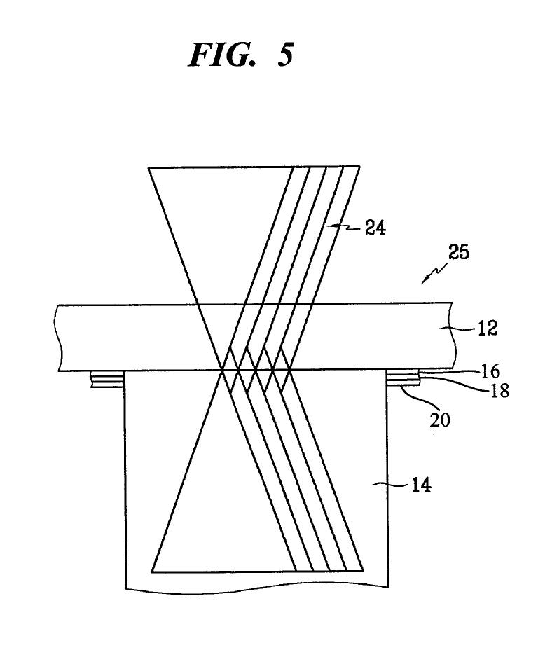

FIGS. 3 through 5 are schematic views illustrating sequential processes for joining parts together according to an embodiment of the present invention.

Referring first to FIG. 3, spacer 14 that is one of the parts to be joined together is arranged on substrate 12 that is the other of the parts. At this point, spacer 14 is arranged perpendicularly to the major axial dimension of substrate 12. Substrate 12 and spacer 14 are formed of glass.

Substrate 12 may be an anode substrate of the electron emission display. At this point, an indium tin oxide (ITO) layer 16, a black layer 18 that is called a black matrix (BM), a metal layer 20 formed of, for example, aluminum may be formed sequentially on the substrate 12. Since ITO layer 16, black layer 18, and metal layer 20 are well known in the art, a more detailed description thereof will be omitted here.

In this embodiment, spacer 14 is formed with a bar, or rectangular shape and arranged on the metal layer 20 with respect to the black layer 18.

When spacer 14 is arranged on substrate 12, as shown in FIG. 4, substrate 12 is irradiated by a first laser beam 22 in a direction normal to interface 17 between substrate 12 and spacer 14.

At this point, as described above, first laser beam 22 is controlled by the laser control unit such that first laser beam 22 has a predetermined energy and is focused on interface 17.

In this embodiment, in order to generate first laser beam 22, a third harmonic Nd:YGA laser having an energy of 4.5 W is used.

First laser beam 22 dissolves and removes ITO layer 16, black layer 18 and metal layer 20 that have been formed on substrate 12 before substrate 12 and spacer 14 are thermally joined together.

Then, as shown in FIG. 5, the interface between substrate 12 and spacer 14 is irradiated by second laser beam 24. The energy of second laser beam 24 is approximately one watt lower than that of first laser beam 22.

Second laser beam 24 functions to thermally bond substrate 12 and spacer 14 together. That is, substrate 12 and spacer 14 are thermally joined together by second laser beam 24, thereby forming anode assembly 25.

As described above, parts such as substrate 12 and spacer 14 are irradiated by sequential application with laser beams 22, 24 of different energy so that parts 12, 14 can be directly joined together.

In an actual process, a plurality of spacers 14 are arranged on substrate 12 and spacers 14 are simultaneously thermally joined, or bonded, onto the substrate 12 by laser beams 22, 24 exhibiting different energy emitted by the corresponding lasers.

In this embodiment, although the spacer is joined on the anode substrate, the present invention is not limited to this example. For example, the joinder method of the present invention can be applied for joining the spacer onto a cathode substrate.

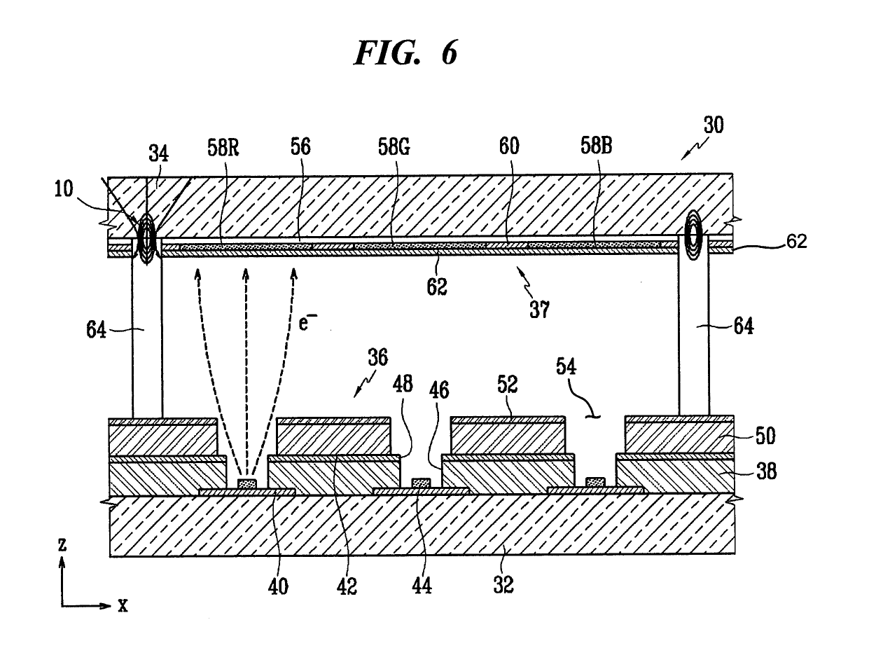

FIG. 6 is a sectional view of an electron emission display having a vacuum envelope constructed according to the principles of the present invention. In this embodiment, an FEA electron emission display is used as an exemplar.

Referring to FIG. 6, an electron emission display 30 of this embodiment includes a vacuum envelope having first (cathode) and second (anode) substrates 32 and 34. A sealing member (not shown) is provided at the peripheries of first and the second substrates 32, 34 to seal substrates 32, 34 together.

An electron emission unit 36 designed to emit electrons is provided on first substrate 32 and a light emission unit 37 configured to display varying video images when excited by the electron beams generated by electron emission unit 36, is provided on second substrate 34.

Electron emission unit 36 includes cathode electrodes 40, gate electrodes 42 interlinking the cathode electrodes 40 by crossing cathode electrodes 40 at right angles with a first insulating layer 38 between gate electrodes 42 and cathode electrodes 40, and a plurality of electron emission regions 44 formed on cathode electrodes 40.

When the crossing regions of cathode electrodes 40 and gate electrodes 42 define pixel regions, electron emission regions 44 are formed at the respective pixel regions and openings 46 and 48 corresponding to the respective electron emission regions 44 are formed through first insulating layer 38 and gate electrodes 42 to expose electron emission regions 44 on first substrate 32.

Electron emission regions 44 are formed of a material emitting electrons when an electric field is applied thereto under a vacuum atmosphere, such as a carbonaceous material or a nanometer-sized material. In other words, the electron emission regions 44 can be formed of carbon nanotubes, graphite, graphite nanofibers, diamonds, diamond-like carbon, C60 (fullerene), silicon nanowires or a combination thereof.

Alternatively, electron emission regions 44 can be tips formed of a Mo-based or Si-based material.

A focusing electrode 52 can be formed on gate electrodes 42 and first insulating layer 38. A second insulating layer 50 is placed under focusing electrode 52 to insulate focusing electrode 52 from gate electrodes 42, and openings 54 are formed through focusing electrode 52 at the respective pixel regions to generally focus the electrons emitted from the corresponding pixel regions. Alternatively, openings 54 can be formed to correspond to electron emission regions 44 in order to independently focus the electrons emitted from those electron emission regions 44.

Light emission unit 37 includes ITO layer 56 formed on second substrate 34, red (R), green (G) and blue (B) phosphor layers 58R, 58G and 58B formed on ITO layer 56, and black layers 60 arranged between R, G and B phosphor layers 58R, 58G and 58B to enhance the contrast of the screen upon which the visual images are displayed. Each crossing region of cathode electrodes 40 and gate electrodes 42 corresponds to a single color phosphor layer.

A metal layer 62 formed of, for example, aluminum, is formed on the R, G and B phosphor layers 58R, 58G and 58B and black layer 60. Metal layer 62 receives a high voltage required to accelerate the electron beams, and reflects the visible light rays which are radiated from R, G and B phosphor layers 58R, 58G and 58B to the first substrate 32, towards the second substrate 34, thereby increasing the screen's luminance.

Spacers 64 are arranged between first and the second substrates 32 and 34 to support the vacuum envelope against the pressure applied thereto and to maintain a gap between first and second substrates 32, 34. Spacers 64 are located in correspondence with black layers 60 so that spacers 64 do not block the areas occupied by R, G and B phosphor layers 58R, 58G and 58B. Spacers 64 are directly joined to second substrate 34 according to the above-described joining method.

Although the FEA type electron emission display is described as an exemplar of the present invention, the present invention is not limited to the exemplar. That is, the present invention can be applied to other types of electron emission displays.

Furthermore, the present invention can also be applied to a backlight unit used as a light source in a flat panel display such as a liquid crystal display.

According to the present invention, since the parts are joined together without using any adhesive material, the manufacturing process can be simplified. In addition, all damages caused by the adhesive material are avoided in advance.

Therefore, the productivity of the electron emission displays requiring the spacers can be improved.

Furthermore, since the joinder of the structure of the spacers is improved, the screen size of the flat display can be more enlarged according to consumers' preferences.

Although exemplary embodiments of the present invention have been described in detail hereinabove, it should be clearly understood that many variations and/or modifications of the basic inventive concept taught herein still fall within the spirit and scope of the present invention, as defined by the appended claims.

What is claimed is:

1. A joining method comprising:
arranging parts that will be joined together such that the parts contact each other; and
irradiating a laser beam toward an interface between the parts through one of the parts in a direction normal to the interface to form a thermal-joining portion around the interface.

2. The joining method of claim 1, wherein the irradiating the laser beam is performed by sequentially irradiating laser beams of different energies.

3. The joining method of claim 1, wherein the irradiating the laser beam includes irradiating a first laser beam having a predetermined energy and irradiating a second laser beam having an energy lower than the predetermined energy of the first laser beam.

4. The joining method of claim 1, further comprising focusing the laser beam on the interface.

5. The joining method of claim 1, wherein the laser beam is generated by a solid state laser.

6. The joining method of claim 5, wherein the solid state laser is the third harmonic Nd/YAG laser.

7. The joining method of claim 1, wherein the laser beam is generated by a UV eximer laser.

8. The joining method of claim 1, wherein the laser beam is generated by a laser having a wave of a visible ray or a near infrared ray.

9. The joining method of claim 8, wherein the laser is selected from the group consisting of a fundamental harmonic Nd/YAG laser, a second harmonic Nd/YAG laser and a diode laser.

10. The joining method of claim 1, wherein the parts are formed of glass.

11. The joining method of claim 1, wherein the parts are formed in a plate shape and one of the parts are arranged on the other of the parts in a perpendicular direction.

12. The joining method of claim 11, wherein a width of the interface is equal to or greater than 0.07 mm.

13. A vacuum envelope comprising:
first and second substrates facing each other; and
a spacer arranged between the first and second substrates and joined on the first substrate in a state where the spacer directly contacts the first substrate.

14. The vacuum envelope of claim 13, wherein the first substrate and the spacer are joined together by a laser beam.

15. The vacuum envelope of claim 14, wherein a thermal-joining portion is formed around an interface between the first substrate and the spacer by the laser beam.

16. The vacuum envelope of claim 13, wherein the thermal-joining portion is formed in a spot having a longitudinal diameter with reference to longitudinal sections of the first substrate and the spacer.

17. The vacuum envelope of claim 16, wherein the thermal-joining portion has a contour line.

18. The vacuum envelope of claim 13, wherein the first substrate and the spacer are formed of glass.

19. An electron emission display comprising:
a cathode substrate on which an electron emission unit is provided;
an anode substrate on which a light emission unit is provided; and
a spacer arranged between the cathode and anode substrate and joined on the anode substrate,
wherein the spacer is joined on the anode substrate in a state where the spacer directly contacts the anode substrate.

20. The electron emission display of claim 19, wherein the anode substrate and the spacer are joined together by a laser beam.

21. The electron emission display of claim 19, wherein a thermal-joining portion is formed around an interface between the anode substrate and the spacer by the laser beam.

22. The electron emission display of claim 19, wherein the thermal-joining portion is formed in a spot having a longitudinal diameter with reference to longitudinal sections of the anode substrate and the spacer.

23. The electron emission display of claim 22, wherein the thermal-joining portion has a contour line.

24. The electron emission display of claim 19, wherein the anode substrate and the spacer are formed of glass.

25. The electron emission display of claim 19, wherein the spacer is formed in a bar-shape.

26. The electron emission display of claim 10, wherein the electron emission display is an EFA type electron emission display.

27. An anode assembly of an electron emission display, comprising:
a substrate;
a light emission unit provided on the substrate; and
a spacer joined on the substrate in a state where the spacer directly contacts the substrate.

28. The anode assembly of claim 27, wherein the substrate and the spacer are joined together by a laser beam.

29. The anode assembly of claim 27, wherein a thermal-joining portion is formed around an interface between the substrate and the spacer by the laser beam.

30. The anode assembly claim 27, wherein the thermal-joining portion is formed in a spot having a longitudinal diameter with reference to longitudinal sections of the substrate and the spacer.

31. The anode assembly of claim 27, wherein the thermal-joining portion has a contour line.

32. The anode assembly of claim 27, wherein the substrate and the spacer are formed of glass.

33. The anode assembly of claim 27, wherein the spacer is formed in a bar-shape.

34. A method of manufacturing an electron emission display, comprising:
arranging a spacer such that the spacer directly contacts one of anode and cathode substrates; and
irradiating a laser beam toward an interface between the spacer and the one of the anode and cathode substrates in a direction normal to the interface to form a thermal-joining portion around the interface.
